(19) United States
(12) Patent Application Publication
(10) Pub. No.: US 2008/0244163 A1
(43) Pub. Date: Oct. 2, 2008

(54) PORTABLE DATA ACCESS DEVICE

(75) Inventors: Hong-Chan Ma, Taipei (TW); Ai-Hui Chen, Taipei (TW); Ming-Yueh Wu, Taipei (TW); Kuo-Lung Chiu, Taipei (TW); Ho-Han Lee, Taipei (TW)

Correspondence Address: PEARNE & GORDON LLP, 1801 EAST 9TH STREET, SUITE 1200, CLEVELAND, OH, 44114-3108, US

(73) Assignee: Chunghwa Telecom Co., Ltd., Taipei (TW)

(21) Appl. No.: 11/940,536

(22) Filed: Nov. 15, 2007

(30) Foreign Application Priority Data
Mar. 30, 2007 (TW) 096205150

(51) Int. Cl. G06F 12/14; G06F 12/00; G06F 12/02

(52) U.S. Cl. 711/103; 711/164; 711/163; 711/154; 711/E12.094; 711/E12.008

(57) ABSTRACT

A portable data access device is applicable to a data processing system. The portable data access device includes at least a first data access sector preset to be a read-only data access sector, for storing at least data and/or application programs executable by the data processing system; at least a second data access sector set to be a general data access sector; and a controller for interfacing with the data processing system and controlling data access to the first data access sector and the second data access sector. The data processing system may execute the application programs and/or access the data through the portable data access device, and the risk of modifying or damaging the data and/or application programs can be reduced by the read-only data access sector.

### FIELD OF THE INVENTION

The present invention relates to data access devices, and more particularly, to a portable data access device applicable to a data processing device.

### BACKGROUND OF THE INVENTION

As the data storage technology advances, a nonvolatile storage device, such as hard disk drive or flash memory, has been made compact in size and with a large data storage capacity. The hard disk drive may be of 2.5 inch or a micro hard disk drive. The flash memory may be a compact flash, smart media, MMC, secure digital, memory stick, and NAND or NOR flash memory of xD specification.

The above nonvolatile storage device may be constructed in a portable multi-media data processing system having multi-media storage, playing and/or editing functions (such as personal computer, notebook computer, cell phone, personal digital assistant (PDA), digital camera, or MP3 player) or any other similar data processing system. The nonvolatile storage device may also be incorporated with connection terminals having a data input/output port specification of USB, IEEE1394, etc. to support the data processing system so as to provide additional or external data access paths for the data processing system.

Flash memories of different specifications may be directly constructed in different data processing systems (such as PDA, digital camera or cell phone) to provide data access for the data processing systems. They may also be combined with control modules responsible for data transmission and connection terminals of various data input/output port specifications to form a typical portable data access device. It is understood that, the hard disk drive may also serve as an additional/external data access device for the data processing system by means of an interface supporting USB connection terminals.

Currently, it is common for a portable data access device to have a flash memory with a data storage capability exceeding one gigabyte. A user not only may store document files in the portable data access device but also may take advantage of application programs (such as basic input output system (BIOS) or operating system) that are stored in the portable data access device and executable by the data processing system. In addition, in order to allow the user to efficiently use the large storage capacity, there has been proposed a portable data access device with divided data storage sectors as, such that the user may divide the portable data access device into one or more data access sectors, similar to dividing virtual sectors of a hard disk drive.

However, the above conventional technology encounters a significant problem, that is, the user may access or modify (add or delete), without authorization, data and/or application programs stored in the above one or more data access sectors. In particular, when the stored data and/or application programs are important data, application programs or operating systems, the unauthorized access or modification would cause these data and/or application programs unavailable when they are required for urgent use. Moreover, again if the user may access or modify the stored data without authorization, the portable data access device, when applied to the data processing system, may be infected by malicious viruses or “Trojan horses”, or modified or damaged by an unauthorized user, such that the data and/or application programs similarly become unavailable or damaged. Besides a USB portable data access device, a general external hard disk drive would also encounter the above data security problems.

Therefore, the problem to be solved herein is to provide a portable data access device, which is able to effectively protect data stored therein from unauthorized modification or damage, so as to increase the safety and convenience in using the portable data access device.

### SUMMARY OF THE INVENTION

In view of the drawbacks of the prior art, an objective of the present invention is to provide a portable data access device having a preset read-only data access sector, such that the risk of modifying or damaging data and/or application programs stored in the read-only data access sector can be reduced.

Another objective of the present invention is to provide a portable data access device, which allows a data processing system, to which the portable data access device is applicable, to execute a boot process, a data recovery process and/or a data backup process through the portable data access device.

Still another objective of the present invention is to provide a portable data access device, which allows a data processing system, to which the portable data access device is applicable, to identify the identity of a user through the portable data access device.

A further objective of the present invention is to provide a portable data access device, which allows a data processing system, to which the portable data access device is applicable, to perform network connection and remote data access through the portable data access device.

In accordance with the above and other objectives, in an aspect, the present invention proposes a portable data access device, which is applicable to a data processing system. The portable data access device includes at least a first data access sector preset to be a read-only data access sector, for at least storing data and/or application programs executable by the data processing system; at least a second data access sector set to be a general data access sector; and a controller for communicating with the data processing system and controlling data access to the first data access sector and the second data access sector.

In another aspect, the present invention provides a portable data access device applicable to a data processing system, the portable data access device including at least a first data access sector preset to be a hidden read-only data access sector, for at least storing data and/or application programs executable by the data processing system; at least a second data access sector set to be a general data access sector; and a controller for communicating with the data processing system and controlling data access to the first data access sector and the second data access sector.

Compared with the conventional portable data access device, the portable data access device of the present invention allows the data processing system to execute the application programs and/or access the data through the portable data access device, and also allows the risk of modifying (adding/deleting) or damaging the data and/or application programs to be reduced by the read-only data access sector.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing the architecture of a portable data access device in accordance with the present invention.

### DETAILED DESCRIPTION OF THE PREFERRED EMBODIMENTS

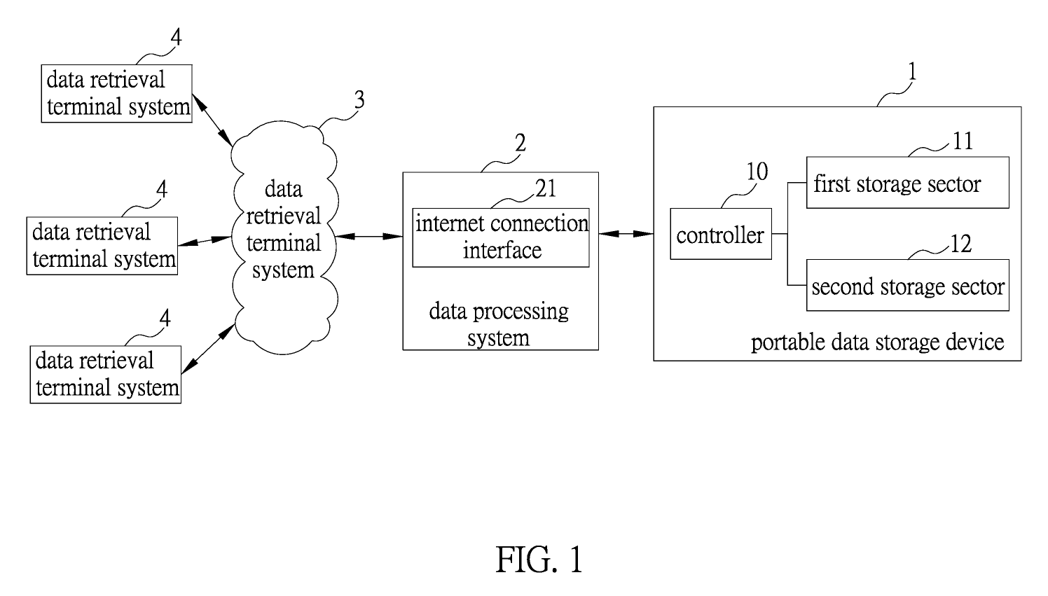

Preferred embodiments of a portable data access device proposed in the present invention are described as follows with reference to FIG. 1. It should be understood that the drawing is a simplified schematic diagram only showing the components relevant to the present invention, and the layout of components could be more complicated in practical implementation.

### First Embodiment

FIG. 1 is a schematic diagram showing the architecture of a portable data access device 1 in accordance with the present invention. As shown in FIG. 1, the portable data access device 1 is applicable to a data processing system 2. In this embodiment, the portable data access device 1 is, for example, a USB portable data access device, that is, the portable data access device 1 is provided with one or more connection terminals having a data input/output port specification complying with the USB specification, and has a dada storage specification complying with that of a NAND flash memory. It should be understood that, in other embodiments, the portable data access device 1 may be provided with one or more connection terminals having other data transmission specifications such as IEEE1394, and may has a data storage specification complying with that of a NOR flash memory or a hard disk drive.

The data processing system 2 may be a system having a data processing function, such as, but not limited to, a cell phone, a palm computer, a hand-held computer, a notebook computer, a personal computer, a server or a workstation.

The portable data access device 1 includes a controller 10, at least a first data access sector 11, and at least a second data access sector 12.

The controller 10 interfaces and communicates with the data processing system 2, and controls data access to the first data access sector 11 and the second data access sector 12.

The first data access sector 11 is preset to be a read-only data access sector, and pre-stores data and/or application programs that can be executed by the data processing system 2. Particularly, the data processing system 2 can only read data (including application programs and/or document files) stored in the first data access sector 11, but cannot write any data into the first data access sector 11.

In this embodiment, the first data access sector 11 stores, but not limited to, BIOS, operating system, system recovery application program, virus scan/isolation/removal application program, backup data, identity identification application programs, network connection application program, network browser application program, and/or data access management application program.

Preferably, in this embodiment, providing that a hard disk drive of the data processing system 2 is infected by malicious viruses and/or some sectors in the hard disk drive are damaged, if a user intends to execute a boot process through the portable data access device 1 of the present invention, the user may use the portable data access device 1 as an additional or external USB data access device, such as USB HDD or USB CD-ROM, when the data processing system 2 enters a BIOS setting display during a power-on self test (POST) process. The relevant setting procedure, setting parameters and/or name of additional data access device may be different, but such difference is known or apparent to persons skilled in the art and is thus not further detailed here. When the portable data access device 1 is set for the boot process and the data processing system 2 again boots the entire system the portable data access device 1, the data processing system 2 may read and execute the data and/or application programs stored in the portable data access device 1 as required for the boot process.

As described above, in this embodiment, the data processing system 2, during the boot process, may use the portable data access device 1 for booting according to the above setting of the data access device. After the POST process is completed, the data processing system 2 may read an operating system pre-stored in the first data access sector 11 of the portable data access device 1, to enter an operating environment provided by the operating system. It should be understood that, the operating system may be Windows® operating system or any other operating system, which allows the data processing system 2 to execute the system recovery application program, virus scan/isolation/removal application program, backup data, identify identification application program, network connection application program, network browser application program and/or data access management application programs stored in the first data access sector 11.

Preferably, in this embodiment, the identify identification application program is to identify whether a user passes an identity identification certificate verification, for example, whether the user passes the verification performed using a private key, so as to determine whether the user is authorized to use the portable data access device 1 according to the verification result.

More preferably, in this embodiment, the data access management application program stored in the first data access sector 11 may be set to allow the user, who passes the identity identification certificate verification, to execute or read with authorization the system recovery application program, virus scan/isolation/removal application program, backup data, identify identification application program, network connection application program and/or network browser application program stored in the first data access sector 11.

Furthermore, even if the hard disk drive of the data processing system 2 is damaged and malfunctions, as long as the data processing system 2 enters the operating system stored in the first data access sector 11 of the portable data access device 1, it still allows the user to drive a network connection interface 21 of the data processing system 2 through the portable data access device 1 to communicate via a network communication system 3 with a data access terminal system 4 (such as a network server, a file server and/or a data server) and perform remote data access.

The second data access sector 12 may be a general data access sector, and has the same data access attributes as those of a general portable data access device. Compared to the first data access sector 11 set to be a read-only data access sector, the second data access sector 12 allows data stored therein to be, for example, accessed, deleted and/or modified through the data processing system 2. As the data access attributes of the second data access sector 12 are known or apparent to persons skilled in the art, and are thus not further detailed here.

### Second Embodiment

In the second embodiment, the architecture and operating mode of the first data access sector 11 and the second data access sector 12 are substantially same as those in the first embodiment. The second embodiment differs from the first embodiment in that, the first data access sector 11 is preset to be a read-only data access sector as well as be hidden. In other words, in this embodiment, the first data access sector 11 cannot be identified or retrieved by a file management application program in the data processing system 2.

Particularly, when the data processing system 2 operating under an operating system (such as Windows® operating system) executes a file management application program (such as “Windows Explorer” program, “Device Manager” program, and so on) or an application program (such as “My Computer” program) provided by the Windows® operating system and/or execute an application program such as a network browser (e.g. Internet Explorer (IE)) to browse or scan data access sectors of the data processing system 2, the first data access sector 11 would not be browsed or scanned. It should be understood that, the above operating system may also be Linux operating system, and supports file management application programs of the Linux operating system or browses or scans application programs in the data access sectors of the data processing system 2.

Compared to the first embodiment, preferably, in this second embodiment, except the data and/or application programs required for booting or the operating system are pre-stored in the first data access sector 11, other data and/or application programs are stored in the second data access sector 12. This allows the user, when the data processing system 2 enters the operating system, to still access data or execute application programs through the second data access sector 12 that is not hidden.

It should be understood that, in the above two embodiments and other embodiments of the present invention, the number of the first and second data access sectors 11, 12 may be adjusted in accordance with practical requirements.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A portable data access device applicable to a data processing system, the portable data access device comprising:
at least a first data access sector preset to be a read-only data access sector, for storing at least data and/or application programs executable by the data processing system;
at least a second data access sector set to be a general data access sector; and
a controller for interfacing and communicating with the data processing system, and controlling data access to the first data access sector and the second data access sector.

2. The portable data access device of claim 1, wherein the data and/or application programs stored in the first data access sector are selected from the group consisting of BIOS, operating system, system recovery application program, virus scan/isolation/removal application program, backup data, identity identification application program, network connection application program, network browser application program, and data access management application program.

3. The portable data access device of claim 2, wherein the data access management application program allows a user to read the data and/or application programs stored in the first data access sector after the user passes an identity identification certificate verification.

4. The portable data access device of claim 2, wherein the identify identification application program is to identify whether a user has passed an identity identification certificate verification and determine whether the user is authorized to use the portable data access device according to a result of the verification.

5. The portable data access device of claim 4, wherein the identity identification certificate verification comprises a private key.

6. The portable data access device of claim 1 further comprising at least a connection terminal of a data input/output port specification of USB or IEEE1394.

7. The portable data access device of claim 1, wherein the first data access sector and the second data access sector have a data storage specification of a nonvolatile memory.

8. The portable data access device of claim 7, wherein each of the first data access sector and the second data access sector is a NAND flash memory, a NOR flash memory, or a hard disk drive.

9. A portable data access device applicable to a data processing system, the portable data access device comprising:
at least a first data access sector preset to be a hidden read-only data access sector, for storing data and/or application programs executable by the data processing system;
at least a second data access sector set to be a general data access sector; and
a controller for interfacing and communicating with the data processing system, and controlling data access to the first data access sector and the second data access sector.

10. The portable data access device of claim 9, wherein the data and/or application programs stored in the first data access sector are selected from the group consisting of BIOS, operating system, system recovery application program, virus scan/isolation/removal application program, backup data, identity identification application program, network connection application program, network browser application program, and data access management application program.

11. The portable data access device of claim 10, wherein the data access management application program allows a user to read the data and/or application programs stored in the first data access sector after the user passes an identity identification certificate verification.

12. The portable data access device of claim 10, wherein the identify identification application program is to identify whether a user has passed an identity identification certificate verification and determine whether the user is authorized to use the portable data access device according to a result of the verification.

13. The portable data access device of claim 12, wherein the identity identification certificate verification comprises a private key.

14. The portable data access device of claim 9 further comprising at least a connection terminal of a data input/output port specification of USB or IEEE1394.

15. The portable data access device of claim 9, wherein the first data access sector and the second data access sector have a data storage specification of a nonvolatile memory.

16. The portable data access device of claim 15, wherein each of the first data access sector and the second data access sector is a NAND flash memory, a NOR flash memory, or hard disk drive.
